(19) United States
(12) Patent Application Publication
(10) Pub. No.: US 2007/0019799 A1
(43) Pub. Date: Jan. 25, 2007

(54) Network support for call duration announcement upon busy

(75) Inventors: Sandra Lynn True, St. Charles, IL (US); David S. Benco, Winfield, IL (US); Sanjeev Mahajan, Naperville, IL (US); Baoling S. Sheen, Naperville, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/170,840

(22) Filed: Jun. 30, 2005

(51) Int. Cl. H04M 3/42

(52) U.S. Cl. 379/209.01

(57) ABSTRACT

A method of supporting a busy duration indication feature (22) is provided in a telecommunications network (A). The method includes: directing a call from an originating end user terminal (10) to a switching facility (40) of the telecommunications network (A) serving a terminating end user terminal (12) for which the call was intended; detecting if the terminating end user terminal (12) is busy; and, if the terminating end user terminal (12) is busy, providing the originating end user terminal (10) an indicator that reflects a measure related to how long the terminating end user terminal (12) has been busy.

### FIELD

The present inventive subject matter relates to the telecommunication arts. Particular application is found in conjunction with certain types of telecommunication networks, and the specification makes particular reference thereto. However, it is to be appreciated that aspects of the present inventive subject matter are also amenable to other like applications and/or networks.

### BACKGROUND

As is well known in the telecommunications art, when a call cannot be completed to called party (e.g., because the called party is already engaged in another call or is otherwise “off-hook”), the calling party is typically returned a busy signal or other suitable call progress tone from the telecommunications network. In this manner, the calling party is informed or made aware that the called party is busy or otherwise unavailable at the time. Accordingly, assuming the calling party still wishes to reach the called party, the call has to be retried at a later time.

Often, a calling party can be frustrated when receiving a busy signal, especially if they urgently want to contact the called party. It typically becomes even more frustrating when the calling party tries to reach the called party multiple times and keeps getting a busy signal. However, the calling party has no way to gage or estimate how long to wait after receiving a busy signal before retrying their call. That is to say, the calling party does not know if the called party just recently became busy (e.g., is near a beginning of a call) and therefore will be busy for awhile longer, or if the called party has been busy for a significant time (e.g., is nearing an end of a call) and therefore will no longer be busy shortly.

Accordingly, it would be advantageous to provide a calling party greater knowledge of or information about a called party's circumstances, e.g., so the calling party could better estimate or decide when to retry a call to the currently busy called party. For example, depending on how long the called party has been busy, the calling party may be able to estimate how much longer the called party may continue to be busy (e.g., based upon a reasonable or typical call duration), and then choose to retry their call after an appropriate amount of time has past. Alternately, if the called party has been busy for a very long time (e.g., significantly longer than a reasonable or typical call duration), the calling party may conclude, e.g., that the called party's telephone is off the hook, that they have the wrong telephone number or are misdialing, that there may be some other problem, etc., and the calling party can therefore take appropriate action based on this information. Nevertheless, a mere busy signal typically does not provide enough information about the called party's circumstances for a calling party to reliably make decisions such as the foregoing.

In current telecommunication networks, features and/or services are available to subscribers that enhance a called party's availability to a calling party. For example, call waiting is one such well known feature. Generally, when a called party subscribes to call waiting, if they are currently engaged in a first call with another party at the time a second in-coming call is directed to the called party from a calling party, then the called party receives an indication of the waiting call, e.g., a call waiting tone is sent or played to the called party while they are still engaged in the first call. Accordingly, the called party has the option of answering the waiting call, i.e., the second call from the calling party. In the meantime, rather than getting a busy signal, the calling party is returned a suitable call progress tone, e.g., ringing.

Generally, call waiting eases the frustration associated with busy signals by enhancing a called party's availability to a calling party. However, call waiting remains the option of the called party, not the calling party. That is to say, the called party chooses whether or not to subscribe to or activate the call waiting service. Moreover, while call waiting tends to be widely used, it has not been universally adopted. Accordingly, a calling party's expectation of not getting a busy signal may tend to be heightened, and therefore, receiving a busy signal or multiple busy signals on successive call retries (e.g., when a called party does not subscribe to call waiting) is all the more frustrating.

Accordingly, a new and improved telecommunications service and/or feature is disclosed that overcomes the above-referenced problems and others.

### SUMMARY

In accordance with one embodiment, a method of supporting a busy duration indication feature is provided in a telecommunications network. The method includes: directing a call from an originating end user terminal to a switching facility of the telecommunications network serving a terminating end user terminal for which the call was intended; detecting if the terminating end user terminal is busy; and, if the terminating end user terminal is busy, providing the originating end user terminal an indicator that reflects a measure related to how long the terminating end user terminal has been busy.

In accordance with another embodiment, a system for supporting a busy duration indication feature in a telecommunications network includes: routing means for directing a call from an originating end user terminal to a switching facility of the telecommunications network serving a terminating end user terminal for which the call was intended; detecting means for detecting if the terminating end user terminal is busy; and, indicating means for providing the originating end user terminal an indication if the terminating end user terminal is detected to be busy by the detecting means, the indication reflecting a measure related to how long the terminating end user terminal has been busy.

In accordance with yet another embodiment, an originating switching facility of a telecommunications network serves and is operatively connected to an originating end user terminal. The originating switching facility includes: a telecommunications switch operative to direct a call from the originating end user terminal to a terminating switching facility serving a terminating end user terminal for which the call is intended; and, a busy duration indication service. The service is operative to: obtain a status of the terminating end user terminal as busy or not busy; if the terminating end user terminal is busy, determine a duration of the busy status; and, provide the originating end user terminal an indication of the duration.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a block diagram illustrating an exemplary telecommunications network suitable for practicing aspects of the present inventive subject matter.

FIG. 2 is a flow chart showing an exemplary process embodying aspects of the present inventive subject matter.

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications art without further detailed explanation as to their configuration or operation except to the extent they have been modified or altered in accordance with and/or to accommodate the preferred embodiment(s) presented herein.

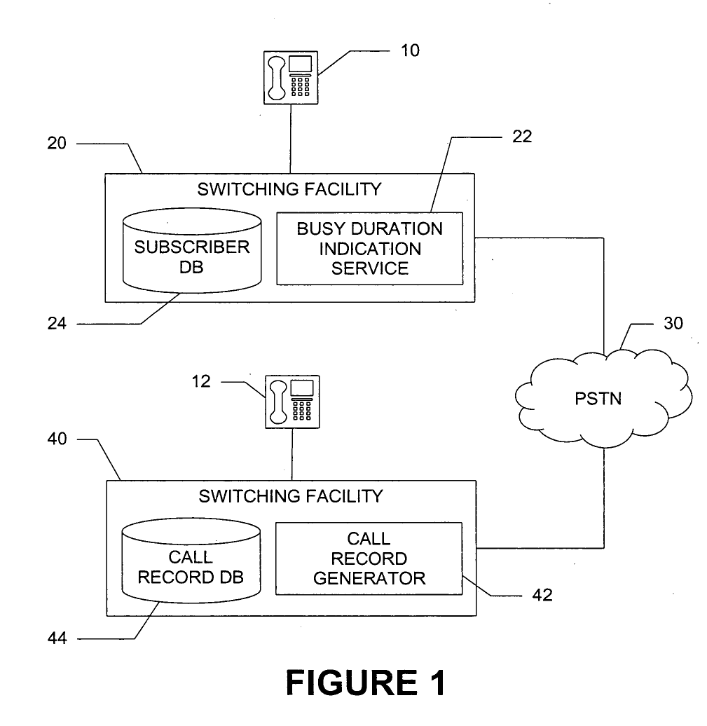

With reference to FIG. 1, a calling party uses an end user terminal (EUT) 10 to selectively place or otherwise originate a telephone call over a telecommunications network A, e.g., to a terminating EUT 12 used by a called party to selectively receive telephone calls. Suitably, as shown, the originating EUT 10 is served by an originating telecommunications switching facility 20 that is operatively connected to and/or in communication with a public switched telephone network (PSTN) 30 in the usual manner. Similarly, the terminating EUT 12 is served by a terminating telecommunications switching facility 40 that is also operatively connected to and/or in communication with the PSTN 30 in the usual manner. For simplicity and clarity herein, only two terminals and two switching facilities are illustrated in the present example. However, it is to be appreciated that a single switching facility suitably serves a plurality of EUTs in the usual manner and that a plurality of switching facilities are similarly equipped and/or likewise arranged with respect to the PSTN 30. In any event, suitably, either of the switching facilities 20 and/or 40 are provided via any one or more of various suitable implementations.

For example, in the case of a landline or wireline application, the served terminal (10, 12) is optionally a landline telephone or other like end user telecommunication device or landline customer premises equipment (CPE), and the facility (20, 40) serving the terminal is an end office (EO) that is operatively connected to the PSTN 30 in the usual manner. Suitably, the EO includes a telecommunications switch (e.g., a class 5 switch such as the 5ESS or another like switch) to which the served terminal (10, 12) is operatively connected in the usual manner, e.g., via a twisted-pair landline cable or the like. Alternately, the switching facility (20, 40) takes the form of or is otherwise implemented as a private branch exchange (PBX) (which when used herein shall also refer to a private automatic exchange (PAX) and/or a private automatic branch exchange (PABX) and/or a Centrex® system) or another like switching facility that provides the served EUT (10, 12) with access to the PSTN 30.

In a wireless or mobile application, e.g., the switching facility (20, 40) serving the terminal (10, 12) is a mobile switching center (MSC) operatively connected to and/or in communication with the PSTN 30 in the usual manner. Suitably, the MSC is also operatively connected to and/or in communication with a plurality of base stations (not shown) in the usual manner. As is understood in the cellular telecommunication art, each base station (BS) provides an over-the-air radio frequency interface for its respective geographic area or cell. Selectively, the served terminal (10, 12) (which in this case is, e.g., a mobile or wireless telephone or other appropriate mobile station (MS)) is provided telecommunication services and/or otherwise accesses the network via the interface and/or the BS serving the cell in which the MS is located.

As illustrated, the originating switching facility 20 (i.e., the facility serving the originating EUT 10) includes or has access to a busy duration indication service (BDIS) 22. When a called party or the terminating EUT 12 is busy, the BDIS 22 is selectively employed to provide the EUT 10 served by the facility 20 an indicator or signal which reflects or otherwise communicates to the calling party using the EUT 10 a measure related to how long the called party or terminating EUT 12 has been busy, i.e., the duration of the called party's busy status. For example, the indicator provided takes the form of an audible announcement or other suitable signal which conveys to the calling party the duration for which the terminating EUT 12 has been busy, or alternately, a time when the terminating EUT 12 started being busy. Suitably, the BDIS 22 is implemented via a program and/or other appropriate software running on an application server, however, it may alternately be implemented in any suitable fashion and/or on another suitable platform or equipment.

Optionally, the BDIS 22 is only made available to a user of the EUT 10 if they have a proper subscription thereto. Moreover, the feature is optionally activated or deactivated by the subscriber as desired. Accordingly, subscription and/or activation information is maintained, e.g., in a subscriber DB 24 which is queried by the facility 20 to determine the subscription and/or activation status prior to actual implementation of the feature. For example, the subscriber DB 24 optionally has a list stored therein, and/or otherwise maintains data or information that indicates, which EUTs and/or users served by the facility 20 (e.g., identified by their telephone numbers or other like identifiers) do and/or do not subscribe to the feature, and whether or not in a given instance the feature is activated or deactivated.

Suitably, when a calling party places or originates a call from the EUT 10 to a called party (e.g., to the terminating EUT 12), the network A determines if the called party or EUT 12 is busy, i.e., if the EUT 12 is already engaged in a prior call or is otherwise unavailable or off-hook. For example, when the call is placed from the originating EUT 10, the originating facility 20 serving the EUT 10 passes the call through the PSTN 30 where it is directed to the terminating facility 40 serving the terminating EUT 12 that is assigned or otherwise associated with the telephone number or address to which the call was placed. Alternately, the originating facility 20 signals the terminating facility 40 with a signal indicating that a call has been placed to the EUT 12, e.g., using a Signaling System 7 (SS7) protocol or other suitable signaling protocol. The facility 40, in response to receiving the call or the call indicative signal, checks to see or otherwise determines if the EUT 12 is busy (i.e., already engaged in a prior call or otherwise unavailable or off-hook).

Assuming the EUT 12 is already engaged in a prior call and the called party does not subscribe to or otherwise have activated a call waiting feature, the terminating facility 40 returns a busy signal or other suitable call progress tones, e.g., over the PSTN 30, back to the originating facility 20. Normally (i.e., absent a subscription to or activation of the BDIS 22), the originating facility 20 simply relays the returned busy signal or call progress tones to the originating EUT 10. Alternately, the originating facility 20 generates the busy signal or call progress tones itself and supplies them to the originating EUT 10 in response to a signal (e.g., an SS7 signal or the like) received by the originating facility 10 from the terminating facility 40 indicating that the EUT 12 is busy.

On the other hand, assuming the calling party has a proper subscription to the feature and/or that the BDIS 22 is activated for the EUT 10, then the calling party is provided an indication of how long the called party or the EUT 12 has been busy. For example, the originating facility 20 optionally detects the busy signal or call progress tones returned from the terminating facility 40, and in response thereto, the facility 20 provides the EUT 10 an indication of how long the called party has been busy, rather than merely relaying the busy signal or call progress tones to the EUT 10. Alternately, the duration of the called party's busy status (or an indication representative of the same) is provided to the originating EUT 10 from the facility 20 in response to the facility 20 receiving the signal from the terminating facility 40 indicating that the EUT 12 is busy. Suitably, the facility 20 conveys the relevant information about the called party's busy status to the calling party by announcing or playing the same via the EUT 10, although any suitable means are optionally employed to convey this data to the calling party.

As shown, the terminating facility 40 is optionally equipped with and/or otherwise has access to a call record generator 42 and/or a call record DB 44. In the normal course of processing, connecting and/or otherwise handling calls to and/or from the terminal 12, the facility 40 employs the call record generator 42 (e.g., a call detail recording (CDR) system, an automatic message accounting (AMA) system or another like system) in the usual manner to produce a typical call detail record (CDR) and/or other like record for each call. The generated CDRs or other records are normally stored for a period of time, e.g., in the call record DB 44. Suitably, as is known in the art, the records may be periodically collected from the call record DB 44 and used for billing and/or accounting purposes by a telephone company or telecommunications service provider operating the facility 40. A CDR or other like record produced by the call record generator 42 and/or stored in the call record DB 44 optionally includes such information as: a calling party or call origination identifier, e.g., the telephone number of the calling party or originating terminal, a called party or call termination identifier, e.g., the telephone number of the called party or terminating terminal, a start time of the call, an end time of the call, a duration of the call, etc. Optionally, other information may also be included in the record depending on the type of call, the record generating system employed, the type of facility producing the record, etc. This additional information may include, e.g., the quality of service for the call, signal strength, the cell used, the identity of the terminating and/or originating switch, etc.

Suitably, when the BDIS 22 is invoked, the duration of the called party's busy status or another appropriate indicator representative thereof, is obtained by the facility 20 from the call record generator 42 or the call record DB 44. Optionally, the originating facility 20 signals the terminating facility 40 with a request for the appropriate information or data, e.g., the start time or current duration of the call in which the EUT 12 is presently engaged. In response to the request, the terminating facility 40 accesses the call record generator 42 and/or the call record DB 44 to retrieved the requested data and return it to the originating facility 20 which had requested it. Alternately, the information is obtained in any other suitable fashion.

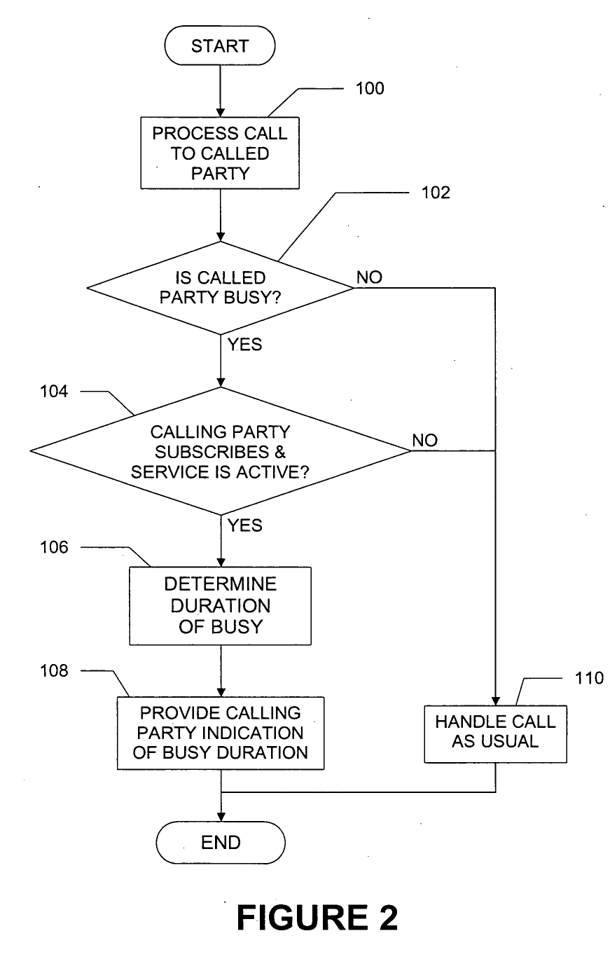

With reference to FIG. 2, operation of the busy duration indication feature and/or service 22 will now be described. The process starts at step 100 with the originating facility 20 processing an originating call from the originating EUT 10 to the terminating EUT 12 served by the terminating facility 40. For example, when the call is placed from the originating EUT 10, the originating facility 20 serving the EUT 10 passes the call through the PSTN 30 where it is directed to the terminating facility 40 serving the terminating EUT 12 that is assigned or otherwise associated with the telephone number or address to which the call was placed. Alternately, the originating facility 20 signals the terminating facility 40 with a signal indicating that the call has been placed to the EUT 12.

At decision step 102, it is determined if the terminating EUT 12 is busy. For example, the terminating facility 40 checks or otherwise determines if the EUT 12 is busy and optionally provides or otherwise sends the originating facility 20 a signal indicative of the same. Alternately, the terminating facility 40 returns the appropriate call progress tones indicative of the EUT's status to the originating facility 20. In either event, based upon a detection of the returned call progress tones or upon receipt of other indicative signaling, the originating facility 20 is made aware of or otherwise determines whether or not the terminating EUT 12 is busy.

If it is determined that the terminating EUT 12 is not busy, then the process branches to step 110 where the call is handled as usual. For example, the facility 40 optionally alerts the terminating EUT 12 and the call progress tones (e.g., ringing) returned from the terminating facility 40 to the originating facility 20 are relayed by the originating facility 20 to the originating EUT 10. Alternately, in response to the originating facility 20 receiving a signal from the terminating facility 40 indicating that the terminating EUT 12 is not busy, the originating facility 20 generates the appropriate call progress tones itself and supplies them to the originating EUT 10.

On the other hand, if it is determined that the terminating EUT 12 is busy, then the process continues to step 104. At decision step 104, it is determined if the originating EUT 10 subscribes to the BDIS 22 and/or if the BDIS 22 is activated for the originating EUT 10. Suitably, this is accomplished by the originating facility 20 querying the subscriber DB 24 to obtain the subscription and/or activation status of the originating EUT 10.

If it is determined that the originating EUT 10 does not subscribe to the BDIS 22 or the BDIS 22 is not activated for the originating EUT 10, then the process branches to step 110 where the call is handled as usual. For example, the facility 40 optionally returns the appropriate call progress tones (e.g., a busy signal) to the originating facility 20, which are in turn relayed by the originating facility 20 to the originating EUT 10. Alternately, in response to the originating facility 20 receiving a signal from the terminating facility 40 indicating that the terminating EUT 12 is busy, the originating facility 20 generates the appropriate call progress tones itself and supplies them to the originating EUT 10.

On the other hand, if it is determined that the originating EUT 10 does subscribe to the BDIS 22 and/or that the BDIS 22 is activated for the originating EUT 10, then the process continues to step 106. At step 106, it is determined how long the terminating EUT 12 has been busy or when the current busy status began for the EUT 12. For example, this information or a suitable indication representative thereof is optionally obtained from the call record generator 42 and/or the call record DB 44. Alternately, it is obtained in any appropriate fashion.

Having obtained the duration for which the EUT 12 has been busy or a suitable indication representative thereof, this information is provided to the calling party or EUT 10, as shown at step 108. Suitably, the originating facility 20 supplies or communicates the busy duration information or representative data to the calling party or originating EUT 10, e.g., by announcing or otherwise playing the same thereto.

As shown, the originating facility 20 and the terminating facility 40 are shown as two distinct facilities serving the originating EUT 12 and the terminating EUT 12, respectively. However, it is to be appreciated, that optionally the same facility serves both the originating EUT 10 and the terminating EUT 12, depending what EUT is being called by the originating EUT 10. Suitably, when the same facility is serving both the originating and terminating EUTs, that facility is optionally equipped or otherwise provisioned similarly to both the illustrated facilities 20 and 40. Of course, with respect to the operation of the service 22, the signaling and/or passing of call progress tones between the two distinct facilities is omitted, however, the operation of the service 22 is otherwise substantially the same as described.

In connection with the particular exemplary embodiments presented herein, certain structural and/or function features are described as being incorporated in defined elements and/or components. However, it is contemplated that these features may likewise, to the same or similar benefit, also be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method of supporting a busy duration indication feature in a telecommunications network, said method comprising:
(a) directing a call from an originating end user terminal to a switching facility of the telecommunications network serving a terminating end user terminal for which the call was intended;
(b) detecting if the terminating end user terminal is busy; and,
(c) if the terminating end user terminal is busy, providing the originating end user terminal an indicator that reflects a measure related to how long the terminating end user terminal has been busy.

2. The method of claim 1, wherein the measure reflected by the indicator is a duration for which the terminating end user terminal has been busy.

3. The method of claim 1, wherein the measure reflected by the indicator is a time when the terminating end user terminal started to be busy.

4. The method of claim 1, wherein the indicator is an audible announcement of the measure.

5. The method of claim 1, further comprising:
prior to step (c), determining if the originating end user terminal has a subscription to the busy duration indication feature; and,
omitting step (c) if the originating end user terminal does not have a subscription to the feature, otherwise performing step (c) if the originating end user terminal does have a subscription to the feature.

6. The method of claim 5, wherein determining if the originating end user terminal has a subscription comprises:
querying a subscriber database in which subscription information is maintained.

7. The method of claim 1, further comprising:
obtaining the measure related to how long the terminating end user terminal has been busy from one of a call record generator or a call record database.

8. The method of claim 1, wherein the facility that serves the terminating end user terminal also serves the originating end user terminal.

9. The method of claim 1, wherein another facility of the telecommunications network, different than the facility serving the terminating end user terminal, serves the originating end user terminal.

10. A system for supporting a busy duration indication feature in a telecommunications network, said system comprising:
routing means for directing a call from an originating end user terminal to a switching facility of the telecommunications network serving a terminating end user terminal for which the call was intended;
detecting means for detecting if the terminating end user terminal is busy; and,
indicating means for providing the originating end user terminal an indication if the terminating end user terminal is detected to be busy by the detecting means, said indication reflecting a measure related to how long the terminating end user terminal has been busy.

11. The system of claim 10, wherein the measure reflected by the indication is a duration for which the terminating end user terminal has been busy.

12. The system of claim 10, wherein the measure reflected by the indication is a time when the terminating end user terminal started to be busy.

13. The system of claim 10, wherein the indicating means provides an audible announcement of the measure.

14. The system of claim 10, further comprising:
a subscriber database in which subscription information is maintained; and,
accessing means for querying the subscriber database to determine if the originating end user terminal has a subscription to the busy duration indication feature, such that the indicating means is disabled if the originating end user terminal does not have a subscription to the feature, otherwise the indicating means is enabled if the originating end user terminal does have a subscription to the feature.

15. The system of claim 10, further comprising:
a call record generator that produces call detail records for the terminating terminal, said call detail records including information pertaining to calls in which the terminating end user terminal participates;
a call record database in which the call detail records are maintained; and,
retrieving means for obtaining the measure related to how long the terminating end user terminal has been busy from one of the call record generator or the call record database.

16. The system of claim 10, wherein the facility that serves the terminating end user terminal also serves the originating end user terminal.

17. The system of claim 10, wherein another facility of the telecommunications network, different than the facility serving the terminating end user terminal, serves the originating end user terminal.

18. In a telecommunications network, an originating switching facility that serves and is operatively connect to an originating end user terminal, said originating switching facility comprising:
a telecommunications switch operative to direct a call from the originating end user terminal to a terminating switching facility serving a terminating end user terminal for which the call is intended; and,
a busy duration indication service operative to:
obtain a status of the terminating end user terminal as busy or not busy;
if the terminating end user terminal is busy, determine a duration of the busy status; and,
provide the originating end user terminal an indication of the duration.
